(19) United States
(12) Patent Application Publication
(10) Pub. No.: US 2008/0270437 A1
(43) Pub. Date: Oct. 30, 2008

(54) Session File Divide, Scramble, or Both for Manual or Automated Processing by One or More Processing Nodes

(75) Inventors: Jonathan Kahn, Crown Point, IN (US); Robert Lee Stephen, Hebron, IN (US)

Correspondence Address: Jordan A. Sigale;Loeb & Loeb LLP, 321 North Clark Street, Chicago, IL, 60610-4746, US

(73) Assignee: Custom Speech USA, Inc., Crown Point, IN (US)

(21) Appl. No.: 11/848,148

(22) Filed: Aug. 30, 2007

Related U.S. Application Data
(63) Continuation-in-part of application No. 11/740,774, filed on Apr. 26, 2007.

(51) Int. Cl. G06F 17/30

(52) U.S. Cl. 707/101; 707/E17.001

(57) ABSTRACT

An apparatus comprising a session file and session file editor with main window and one or more document windows and annotation window and divide/merge and scramble/unscramble features. The session file may include text, audio, image, and other bounded divisions with source data divided into segments or other bounded divisions and other bounded divisions associated to original data. The session file may be derived from processing third-party application output. The session file editor displays text and other content, provides text selection capability and plays back audio of session files with audio-linked text as embedded content, and supports entry of text and password-protected document lock/unlock. The session file editor supports selection of a parent session file and divide, scramble, or merge of bounded divisions to create one or more child session files that may be processed at one or more nodes to create one or more processed child session files. The one or more processed child session files may undergo merge, unscramble, or both to create a reassembled session file with the same order of bounded divisions as the parent session file. The apparatus further comprises export of phrase-toned audio from a session file for transcription into delimited text for insert/replace into the original session file.

### CROSS-REFERENCE TO RELATED APPLICATION

This application is a continuation-in-part of U.S. Non-Provisional application Ser. No. 11/740,774, filed Apr. 27, 2007 entitled “Session File Modification With Locking of One or More of Session File Components,” which claims the benefit of U.S. Non-Provisional application Ser. No. 11/464,445, filed Aug. 25, 2006 entitled “Session File Modification With Selective Replacement of Session File Components,” which claims the benefit of U.S. Non-Provisional application Ser. No. 11/279,551, entitled “Session File Modification with Annotation Using Speech Recognition or Text to Speech,” which claims the benefit of U.S. Non-Provisional application Ser. No. 11/203,671, entitled “Synchronized Pattern Recognition Source Data Processed by Manual or Automatic Means for Creation of Shared Speaker Dependent Speech User Profile,” filed Aug. 12, 2005, which is still pending (hereinafter referred to as the '671 application). The '671 application and previous copending applications are incorporated herein by reference to the extent permitted by law.

### BACKGROUND OF THE INVENTION

1. Field of the Invention

The present invention relates to privacy protection of electronic data.

2. Background Information

Audio, text, and image data may be processed, interpreted, analyzed, or converted by manual or automatic processes or both. For instance, a transcriptionist may playback digital dictation audio using playback software and foot pedal for play, fast forward, and rewind. The operator may transcribe into a word processor such as Word (Microsoft Corporation, Redmond Corporation, Wash.) or WordPerfect® (Corel Corporation, Ottawa, Canada). The text file may be reviewed and approval by a dictating physician, lawyer, or other speaker.

Dictation audio may also be transcribed using real-time or server-based automatic speech recognition. Unlike standard text processors, speech recognition for dictation outputs session files with audio-linked text. With a session file loaded into an appropriate read/write software application, the user may select text, playback the associated audio, modify the text, and save the text-modified session file. Examples of speech recognition for dictation include Dragon NaturallySpeaking® (Nuance Communications, Inc.), IBM ViaVoice® (IBM, Armonk, N.Y.), Philips® SpeechMagic® (Vienna, Austria), Microsoft® Windows® Vista speech recognition operating system (Microsoft Corporation, Redmond, Wash.), and SweetSpeech™ (Custom Speech USA, Inc., Crown Point, Ind.). One session file editor for selecting speech recognition text and playing back dictation audio using a transcriptionist foot pedal is SpeechMax™ (also available from Custom Speech USA, Inc.).

Other automatic speech and language processing applications may process or output audio or text, such as command and control (voice activation), text-based or phoneme-based audio mining (word spotting), speaker recognition, text to speech, phonetic generation, natural language understanding, and machine translation. Speech and language technologies use pattern recognition approaches found in a variety of applications, such as data capture, boundary definition (segments, areas, volumes, or spaces), elimination of unneeded data, feature extraction, comparison with stored representational models, and conversion, analysis, or interpretation of extracted features. See, e.g., Lawrence Rabiner Biing-Hwang Juang, Fundamentals of Speech Recognition (1993), Xuedong Huang, Alex Acero, Hsiao-Wuen Hon, Spoken Language Processing (2001), Daniel Jurafsky & James H. Martin, Speech and Language Processing (2000), Andrew R. Webb, Statistical Pattern Recognition (2nd ed. 2002).

Health care, law, businesses, government, and other organizations may use encryption, scrambled audio, and other techniques to maintain privacy and confidentiality during transmission of audio, image, or text data before review or processing by a human operator or automated process. Scrambling/unscrambling audio by altering waveform signal has been well described in the prior art. These encryption, scrambling, and other techniques may protect privacy during transmission, but do not limit disclosure by an individual with access to decrypted data, descrambled audio, or otherwise revealed data. By way of example, a transcriptionist may decrypt the encoded dictation files, playback the audio, transcribe the document in a word processor, but still have access to complete information in the document about the patient, client, or business. Similarly, there are similar issues when speech recognition session files or other pattern recognition program are sent to an editor review and correction.

With the growth of transcription outsourcing via the Internet, digital content is now rapidly and widely distributed within and outside of hospitals, clinics, law firms, government, and other organizations to various sites, including to foreign locations. There are additional, unmet needs to limit access to confidential and private communications.

### SUMMARY OF DISCLOSURE

The present disclosure teaches various inventions that address, in part or in whole, this and other various needs in the art. Those of ordinary skill in the art to which the inventions pertain, having the present disclosure before them will also come to realize that the inventions disclosed herein may address needs not explicitly identified in the present application. Those skilled in the art may also recognize that the principles disclosed may be applied to a wide variety of techniques involving data interpretation, analysis, or conversion by human operators, automated systems, or both.

As described in '671 and copending applications, the process of session file creation may begin with capture and division of boundary division of audio, text, image, or other data input. Processing bounded data input may result in session file associating (“linking” or “tagging”) the bounded data input to bounded text, audio, image or other output. Boundary division may consist of a plurality of segments for audio or text data input representing a segmented stream of characters or binary audio data, two-dimensional areas for digital photo, graphics, or other image data (e.g., defined by pixels), or volumes or spaces for three or more dimensional data. After creation of session files by manual or automated processes, human review, automated postprocessing, or both may modify output results or display. This process may result in a complex, multilayered electronic session file with input and output data elements associated to one or more bounded divisions. Rapid evaluation of the bounded output may be assisted by comparison of an index session file with one or more synchronized session files with an equal number of segments.

In an example drawn from transcription, speech recognition software may create a transcribed session file that links the audio to a word or phrase, enabling an operator to select audio-linked text and hear the dictation. Similarly, audio segmentation software may split the audio to create a segmented audio file (untranscribed session file) consisting of one or more audio phrases (utterances). Generally, these utterances represent a few words spoken in succession separated by a short pause (silence) between phrases. In this approach, transcriptionist may play back the segments, transcribe the segments in relation to the audio, and save the text as a transcribed session file with links to phrase audio. With text selection of a phrase, the operator may playback the corresponding phrase audio.

Optionally, forced alignment techniques may be used to create word-level links in manually transcribed session files. These techniques are well-known to those skilled in the speech and technologies art and have been described in '671 and copending applications. In this approach, an operator specifies the audio file and delimited verbatim text file representing the text transcribed manually. This data is submitted to a speech recognition decoder that assigns audio tags to individual words and creates a transcribed session file. With this file, a user may select text of a word, or phrase or longer passage, and playback the audio, thereby mimicking the results of speech recognition.

In another approach to session file creation and modification, an “empty” session file may initially consist of empty bounded divisions containing no data elements. Audio, text, image, and other data elements may be added by manual or automatic processes, or both, to add content and create a completed session file with audio associated to text. In another approach, a “fill-in-the-blank” form session file may be created into which a doctor, lawyer, client, or customer dictates data. The dictation may be processed by manual transcription, speech recognition, or both.

The current disclosure builds upon '671 and copending applications dealing with session file creation and processing. The current disclosure teaches a system and method to enhance privacy and confidentiality. As disclosed in the current application, the process may limit access of any one processing site (node) to bounded data input, reorder bounded data input to make the available data more confusing and less understandable to any single human operator, or both limit access and reorder data content.

In one approach, the disclosure teaches loading a session file into an exemplary session file editor with optional preprocessing to create a parent session file. Preprocessing may include optionally selectively deleting data content and separating data elements into smaller session file segments. The disclosure further discloses optionally dividing parent session file content into two or more session files to send to different nodes or physical locations; optionally scrambling order of the segments of the parent session file to create a single child session file, or both performing divide and scramble to create two or more scrambled child session files; embedding the identifying time stamp within a plurality of child session files; optionally embedding the order data into plurality of child session files or saving order data into a separate, order and time stamp file; encrypting both order and time stamp data; optionally password protecting order and time stamp encryption to prevent unauthorized decryption and reassembly of the plurality of child session files merge, descramble, or both; processing a plurality of child session files by manual or automated processes or both to create a plurality of processed child session files; and merge, unscramble, or both, of a plurality of processed child session files to create a reassembled session file before review at source node or other location. The disclosure further teaches method for detecting and notifying a user of a change in segment number of a processed child session file compared to the original child session file, and also of a missing child or processed child session file.

The disclosure further teaches optionally exporting audio from a child session file that has been divided, scrambled (reordered), or both. In one approach, the parent session file may represent an untranscribed session file or transcribed session file. This option teaches modifying segments of a child session file to include end-phrase tone; exporting audio from this modified session file; distributing audio file with end-phrase tone to manual transcriptionist; playing back audio with attention to end-phrase tones; delimiting transcription for each segment by tab, comma, line, or other means based upon occurrence of audio tones; returning plurality of delimited text segments to source node; verifying that the number of delimited text segments returned equals the number of segments in the one or more child session files; sequentially inserting or replacing delimited text for each child session file to create one or more processed child session files; entering password if required, and reassembling session file by merge, unscramble, or both. The disclosure further teaches checking delimited text segments against segment number of the corresponding child and displaying discrepancy before reassembly. The disclosure further teaches exporting delimited text from one or more child session files of a transcribed session file for review and edit of the text with the corresponding exported audio with end-phrase tones.

A primary object of the present invention is to protect privacy and confidentiality by dividing a parent session file to limit the data content available at any one processing node; reordering segments within a single child session file derived from a single parent session file to make content less understandable; and reordering segments of two or more child session files to make content less obvious to one or more persons at two or more nodes.

Another primary object of the present invention is to reduce job turnaround time by dividing a parent session file to distribute the work across more than one node.

Another primary object of the present invention is to protect privacy and confidentiality and reduce turnaround time by creation of one or more tone delimited child audio files for processing by manual.

Another primary object of the present invention is to provide an easy way to create session files that are divided, scrambled, or both for training and testing in fields related to human cognition and psychology, phonics and phonetics, foreign languages, and other areas.

The disclosed methods and apparatuses may utilize the techniques and apparatus disclosed in Applicants' prior, co-pending patent application referenced hereinabove. Other techniques may be used to capitalize upon these further improvements in the art.

These and other objects and advantages of the present disclosure will be apparent to those of ordinary skill in the art having the present drawings, specifications, and claims before them. It is intended that all such additional systems, methods, features, and advantages be included within this description, be within the scope of the disclosure, and be protected by the accompanying claims.

### BRIEF DESCRIPTION OF THE DRAWINGS

FIGS. 1A, 1B and 1C together comprise a block diagram of an exemplary embodiment of a computer within a system or a system using one or more computers.

FIGS. 2A and 2B together comprise a flow diagram illustrating an overview of an exemplary embodiment of the general process of division/merge and scramble/unscramble applied to a parent session file and one or more resulting child session files.

FIGS. 3A, 3B are diagrams illustrating an exemplary embodiment of session file with data elements text, audio, or images and an empty session file with no data elements.

FIG. 4A (Divide, No Scramble) is a diagram illustrating an overview of an exemplary embodiment of the process of parent session file modification with divide with reference to mapping data.

FIG. 4B (Scramble, No Divide) is a diagram illustrating an overview of an exemplary embodiment of the process of parent session file modification with scramble with reference to mapping data.

FIG. 4C (Divide and Scramble) is a diagram illustrating an overview of an exemplary embodiment of the process of parent session file modification with divide and scramble with reference to mapping data.

FIG. 4D (Mapping Data) is a diagram illustrating an overview of an exemplary embodiment of the session file segments with reference to mapping data, time stamp, and password hash value.

FIGS. 5A (Embed Mapping Data 213→4225), 5B (Extract Mapping Data 241→261), 5C (Export Mapping Data 213-249), and 5D (Import Mapping Data 250→261) are diagrams illustrating an exemplary embodiment of the process of password protection for decryption of session file order and time stamp data.

FIGS. 6A-6Z illustrate an exemplary graphical user interface depicting the process of divide, scramble, or both, and merge, unscramble, or both.

### DETAILED DISCLOSURE

While the present disclosure may be embodied in many different forms, the drawings and discussion are presented with the understanding that the present disclosure is an exemplification of the principles of one or more inventions and is not intended to limit any one of the inventions to the embodiments illustrated.

I. System 100

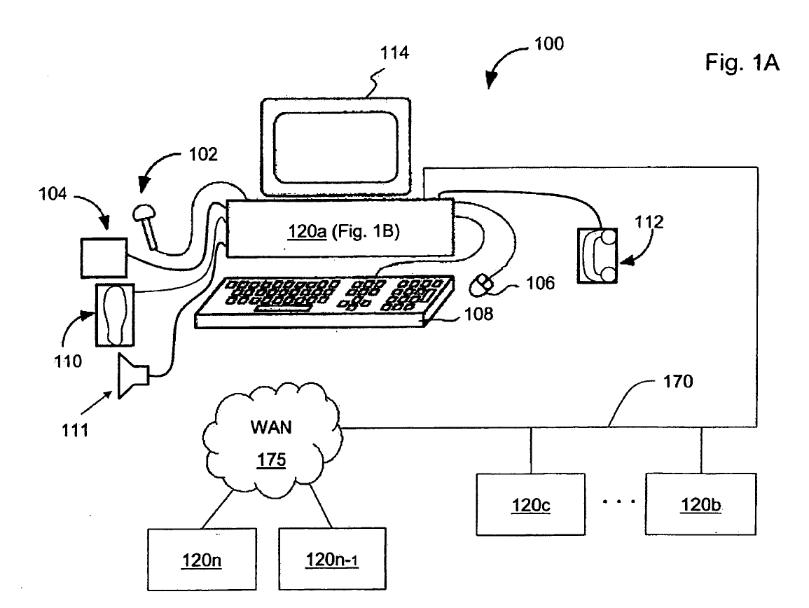

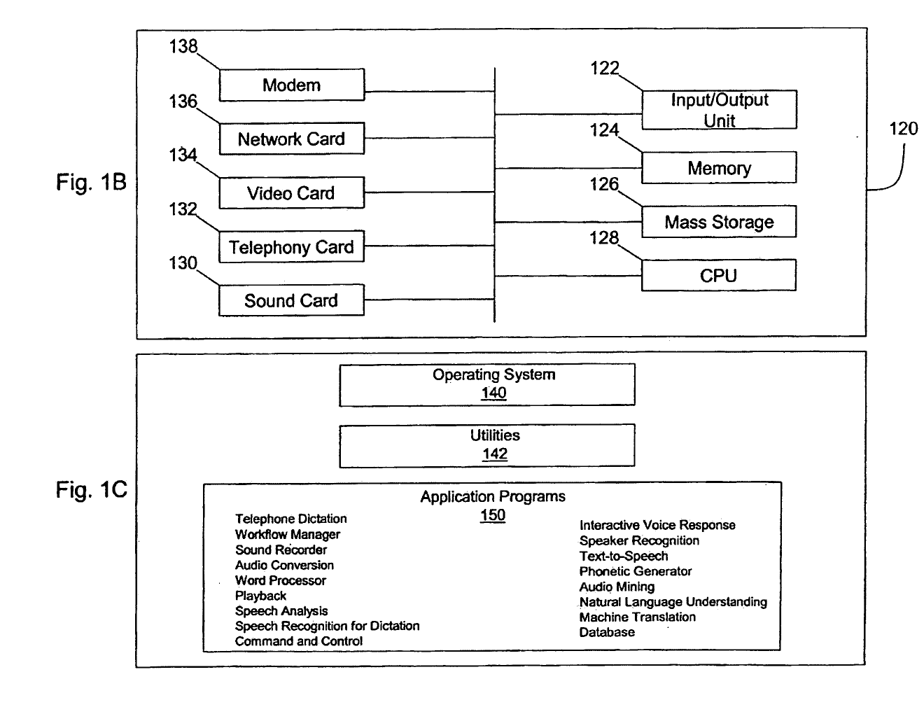

FIGS. 1A, 1B, and 1C together comprise a block diagram of one potential embodiment of a system 100. The system 100 may be part of the invention. Alternatively, the invention may be part of the system 100. The system may consist of functions performed in serial or in parallel on the same computer 120a or across a local 170 or wide area network 175 distributed on a plurality of computers 120b-120n. The computer 120 may be controlled by the Windows® operating system. It is contemplated, however, that the system 100 would work equally well using a Macintosh® operating system or even another operating system such as Linux, Windows CE, Unix, or a Java®based operating system, to name a few.

Each computer 120 may include input and output (I/O) unit 122, memory 124, mass storage 126, and a central processing unit (CPU) 128. Computer 120 may also include various associated input/output devices, such as a microphone 102 (FIG. 1A), digital recorder 104, mouse 106, keyboard 108, transcriptionist foot pedal 110, audio speaker 111, telephone 112, video monitor 114, sound card 130 (FIG. 1B), telephony card 132, video card 134, network card 136, and modem 138. In one embodiment shown in FIG. 1C, memory 124 and mass storage 126 jointly and operably hold the operating system 140, utilities 142, and application programs 150. The applications programs 150 may include software for a variety of functions, including pattern recognition, speech and language processing, and an exemplary session file editor 160.

Session File Editor 160

The session file editor 160 may be the type disclosed in the '671 application and other copending applications. As disclosed, this may be a multiwindow, multilingual text editor oriented to speech and language processing with support of display of images and graphics. It is contemplated that other session file editors may be created to support tasks described in '671 application and other copending applications. In one approach, the session file editor may read/write RTF, .TXT, .HTML, or proprietary .SES format and support Unicode.

This proprietary format may use Hypertext Markup Language (HTML) for display and Extensible Markup Language (XML) for recording of markup of the original segmented data in a session file document. Markup may include structured information, instructions, and history about content. This content may consist of data elements such as audio, text, or images. The process of .SES file creation and modification may involve use of a computer desktop application, offline server-based software, or both. The exemplary graphical user interface is illustrated throughout this patent application within a Windows® operating system environment as a standalone desktop application. This is done solely to exemplify the teachings of the present invention and not limit the invention to use with the Windows® operating system or as standalone software. For example, the invention may be implemented with other operating systems, as a web-based application that opens in a browser, or as a set of instructions embedded in a computer-processing chip.

The session file editor 160 may include a main window with menu and toolbar items for opening, viewing, modifying, and saving files and viewing documentation. The main window may also have menu and toolbar items for plugging that load with the main application. These plugin applications programs 150 may include speech recognition, text to speech, machine translation, other speech and language processing, and other pattern recognition. They may create .SES session files, create other files that are converted to .SES format, or generate audio, text, or image data content for markup of the original .SES file.

The session file editor 160 may also include one or more document windows for read/write of session files and other compatible files, and an annotation window for one or more text and audio annotations (comments) associated to each segment. One or more persons may complete each annotation with an annotation identifier associated to each comment. The text annotation window may also be used to create a dynamic universal resource locator (URL), dynamic file path, or command line to link to websites, open files, or launch programs, including media players.

Among other features, the exemplary session file editor 160 may read/write data elements such as audio, text, and images, display data content by phrase or segment, playback audio with a transcriptionist foot pedal 110, use keyboard tab to sequentially navigate through an index session file in one document window and highlight same number (synchronized) segments of session files displayed in other document windows, text compare synchronized segments in same or foreign language by phrase or across phrase boundaries in two or more document windows, synchronize a synchronized session files with resegmenting and retagging algorithm, create session files for distribution to end users as documents or reports (including multimedia with embedded audio-linked text), produce training session or other files for a user profile or other model for speech and language processing or other pattern recognition, and selectively exclude data material from training files.

The exemplary session file editor 160 may also be used to modify a session file with annotation using speech recognition or text to speech by selectively swapping (transposing) document and annotation text or audio, or copying and pasting annotation text or audio from the annotation window into the main read/write window. With transposing or copying, an operator may select text in the main read/write window and playback audio. An operator may also export audio as a separate file from a session file with audio-linked text. The exemplary session file editor may also be used to selectively replace portions of the audio and associated text within the session file, such that portions of the original audio and text are made inaccessible to users to protect confidentiality, e.g., with a “beep” for deleted audio or “confidential” for deleted text. The session file editor may further support locking of one or more session file components to prevent unauthorized editing. One such session file editor application is SpeechMax™ (available from Custom Speech USA, Inc., Crown Point, IN). Some session file editor functions may also be performed offline by a server-based session processor (also available from Custom Speech USA, Inc.)

In a related approach, a human operator may use the exemplary session file editor 160 to add audio, text, images, or other data markup to one or more empty session files 205, containing boundary divisions only, to create one or more session files 205 in .SES format with content. In one approach, an operator may use the exemplary session file editor 160 to create “fill-in-the-blank” forms for structured dictation. A speaker may dictate into each “blank” of the form using a microphone 102, and record audio with the annotation window sound recorder. In another related approach, a speaker may dictate each sentence separately into a separate segment using the sound recorder functionality of the annotation window. An operator may also import audio files recorded using a digital recorder 104.

The session file editor 160 may also read/write .SES session files 205 produced directly by an offline server application program 150. In one embodiment, a server application (such as SpeechServers™) may process output from SweetSpeech™ speech recognition and speech and language processing toolkit, including (both products available from Custom Speech USA, Inc.). The server-generated one or more session files 205 may represent untranscribed session files (segmented audio) for manual transcription, transcribed session files using speech recognition using automated speech-to-text decoding, session files with audio tags at the word level generated in forced alignment mode, and other session files 205.

In a related approach, the session file editor 160 may also create one or more session files 205 with .SES format directly from SweetSpeech™ plugin for desktop use that loads with the exemplary session file editor 160, or conversion of files derived from third-party application programs 150 incorporated within plugins that also load with the exemplary session file editor 160. The session file editor 160 may also process files from server-based, offline programs running third-party application programs 150. These third-party application programs 150 may include speech recognition, text to speech, machine translation, other speech and language processing, or pattern recognition, such as handwriting or optical character recognition or computer-aided medical diagnosis, to name a few.

Typically, integration of third-party application programs 150 requires a software development kit (SDK) to convert proprietary files into the proprietary read/write .SES session files 205. One example of a development tool is Microsoft® Speech Software Development Kit (Microsoft Corporation, Redmond, Wash.) for speech recognition and text to speech, including speech recognition for Windows® Vista™ operating system. Consequently, the software development kits from different companies can potentially support creation of .SES session files 205 from a wide variety of third-party software application programs 150.

Methods or processes in accordance with the various embodiments of the invention may be implemented by computer readable instructions stored in any media that is readable and executable by a computer system. A machine-readable medium having stored thereon instructions, which when executed by a set of processors, may cause the set of processors to perform the methods of the invention. A machine-readable medium may include any mechanism for storing or transmitting information in a form readable by a machine (e.g., a computer). A machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.).

II. Process 200

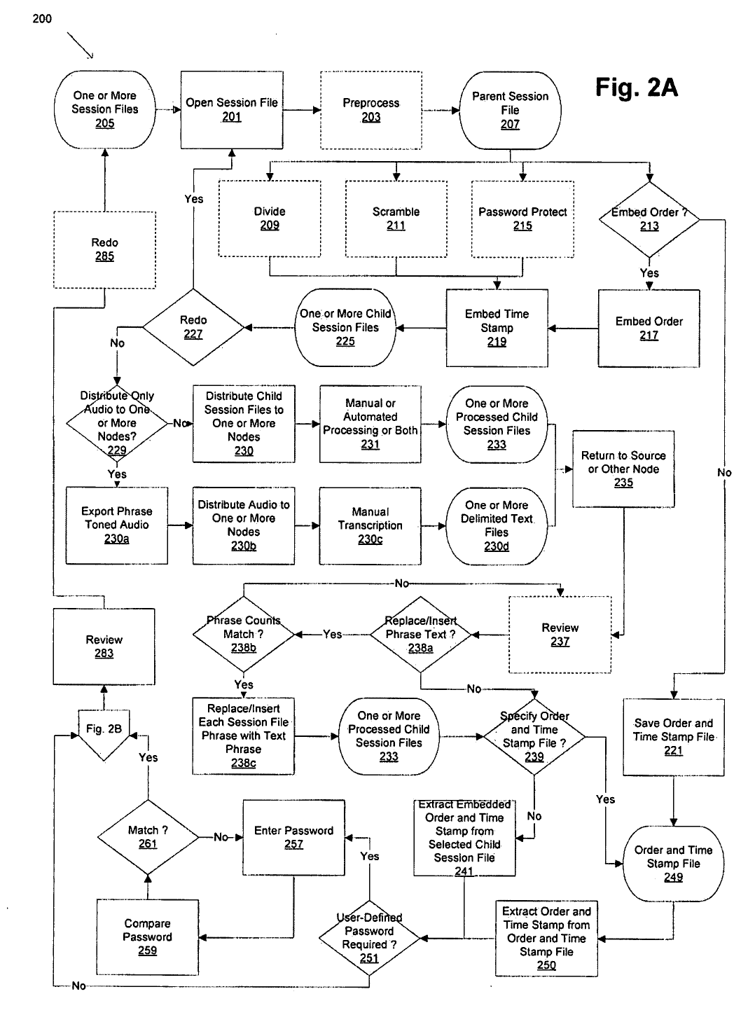

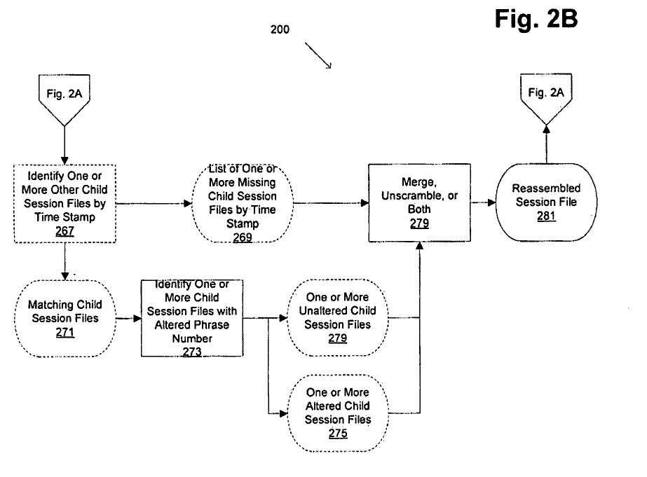

FIG. 2 provides a general overview of the process 200 of creating one or more child session files by division, reordering of segments, or both. The activities may be repeated, order changed, and steps inserted or deleted in actual practice without departing from the spirit and purpose of the invention.

The operator may select from one or more session files 205, and open session file 201 in a session file editor 160 document window, and optionally preprocess session file 203 to create parent session file 207 with 1, . . . , N segments. Optional changes may include selective delete of confidential text, audio, or both, or other data content to remove identifying information. Other changes may include split audio, text phrases, or both, or other data content to limit identifying name information included in single segment (e.g., split “Joseph Michael Block” in a single segment to “Joseph” “Michael” “Block” across three separate segments). The “split” process may create additional segments within the open session file 201 before creation of parent session file 207. An operator may also merge audio, text, or both, or other data content across segment boundaries to promote accurate transcription (e.g., merge “chronic” “obstructive” “lung” “disease” to “chronic obstructive lung disease”); or make other changes to original one or more session files 205.

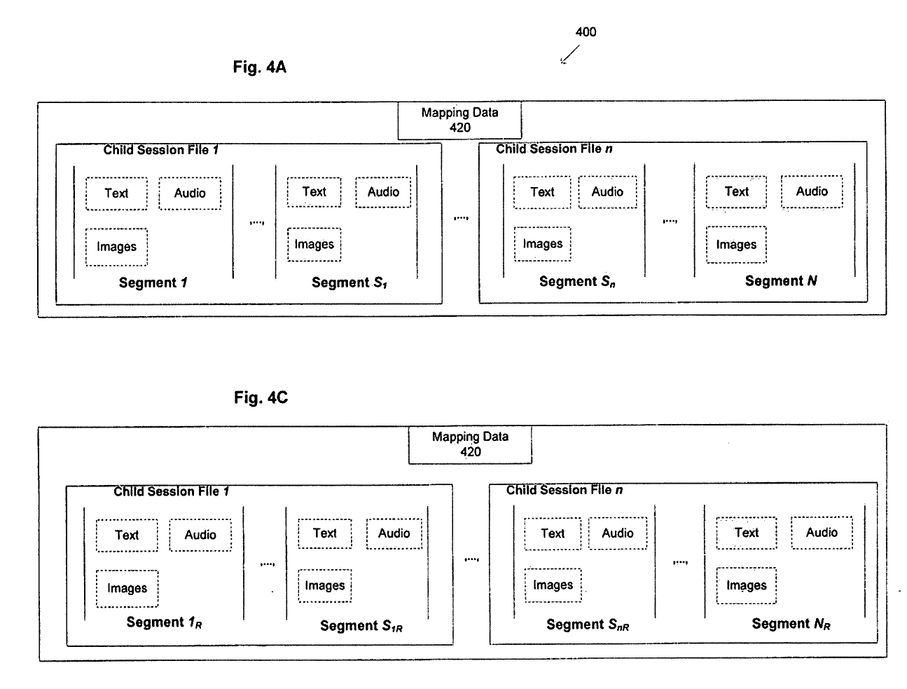

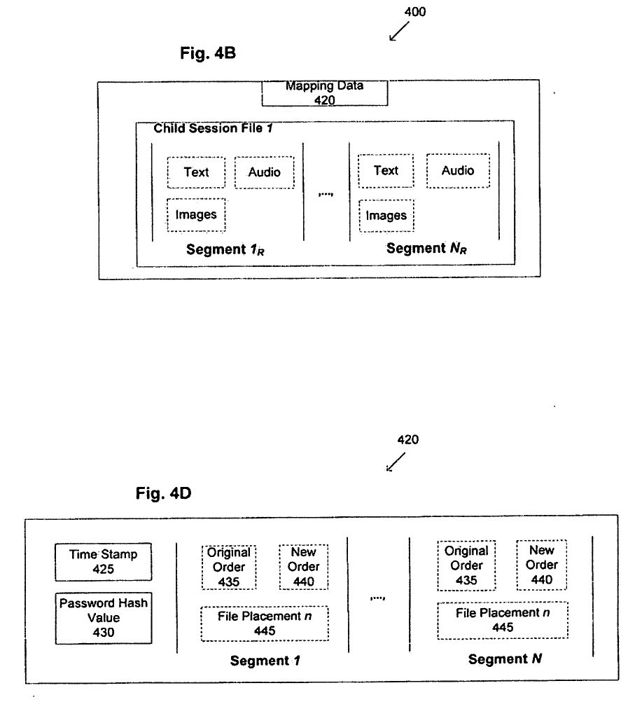

In a preferred approach, selection of divide 209, scramble 211, or both results in embed time stamp 219 data in each of the one or more child session files 225, as illustrated in FIG. 4. Time stamp data may include date, hour, minute, and second/millisecond. In a preferred approach, the time stamp is the same for each of the one or more child session files 225 created by the same divide 209, scramble 211, or both. Time stamp data thereby serves as an identifier for associating a “child” to related “child” session files.

Selection of divide 209, scramble 211, or both also create order mapping 420, as illustrated in FIG. 4. Scramble 211 creates order data mapping the original position of 1, . . . , N parent session file 207 segments to the reordered_1ᵣ, . . . , Nᵣ one or more child session files 225 segments. Divide 209 creates order data mapping the original position of the 1, . . . , N parent session file 207 segments in each of the new one or more child session file 225 segments. If the process includes divide 209, scramble 211, or both, mapping data 420 for both is created. After embed order 213 decision point, user may elect to embed order 217 in one or more child session files 225.

Alternatively, after embed order 213 decision point, the user may elect not to embed order data if there is a perceived risk of unauthorized decryption of this data. In this case, if the user does not embed order, a dialog may prompt the user to save order and time stamp file 221 to external order and time stamp file 249. In one approach, the order and time stamp file 249 has a .DSO extension (“divide scramble order”), and includes mapping data 420 with time stamp, order data, and password hash, as further illustrated in FIG. 4.

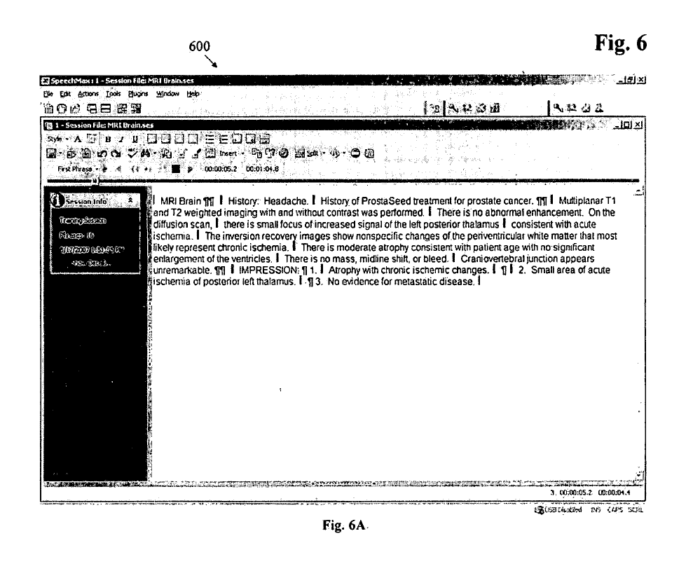

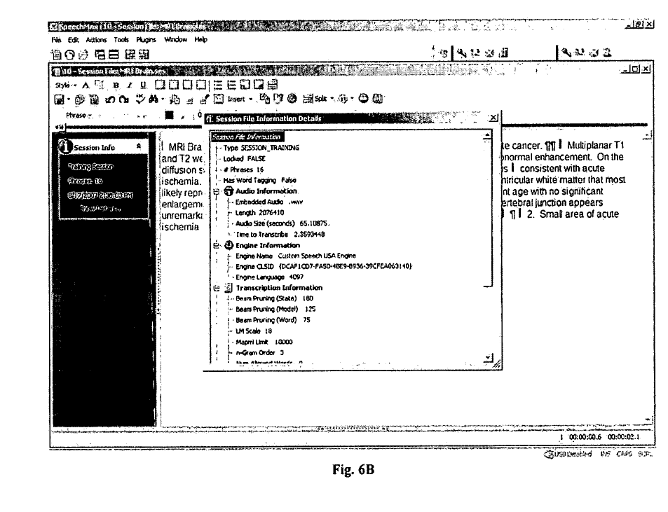

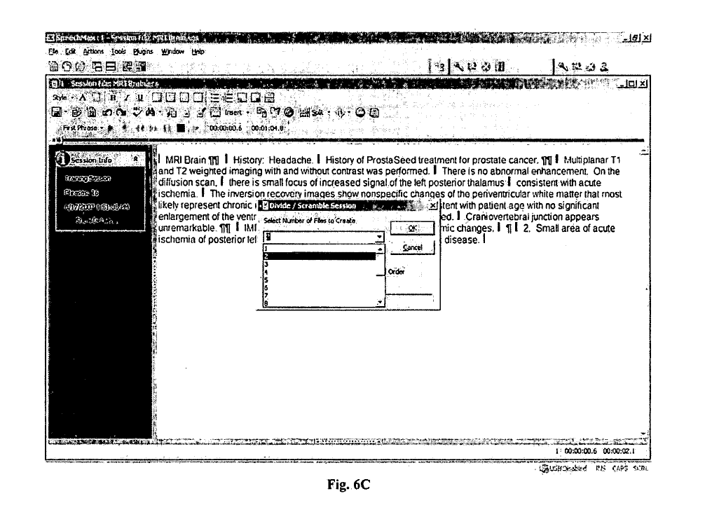

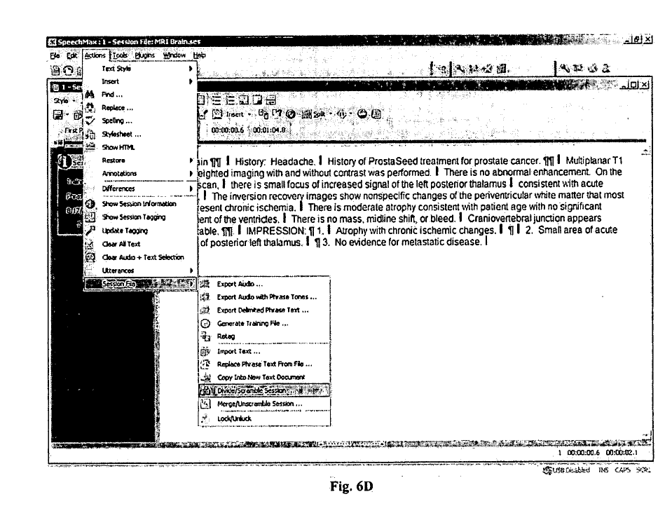

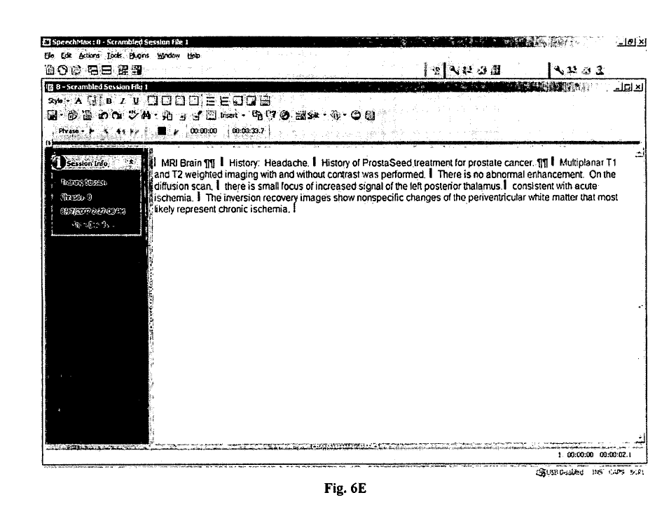

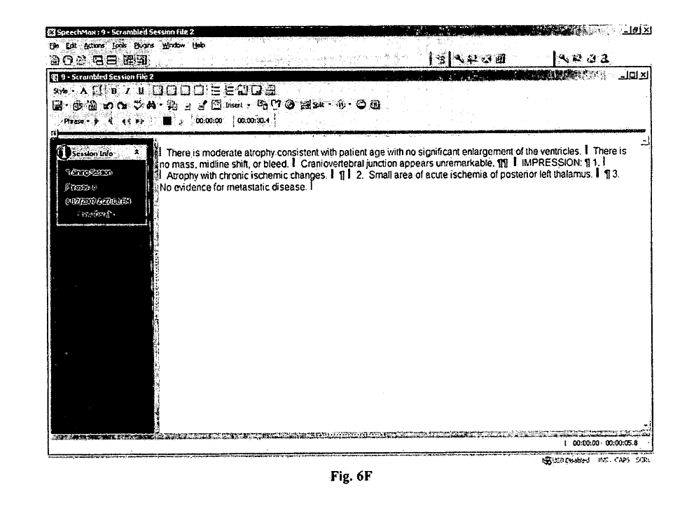

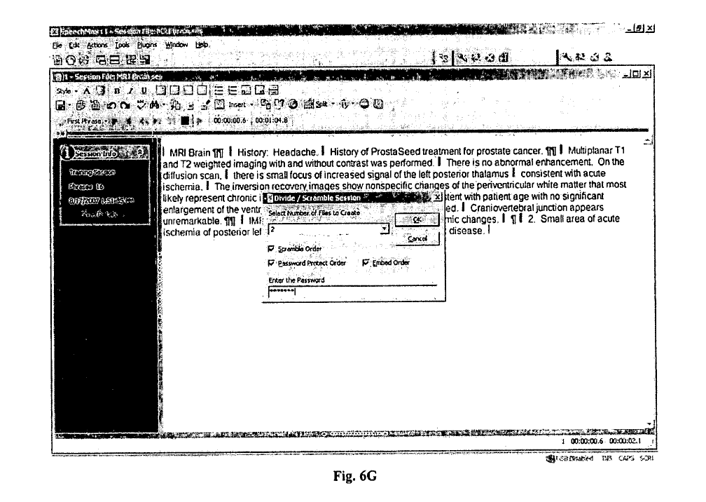

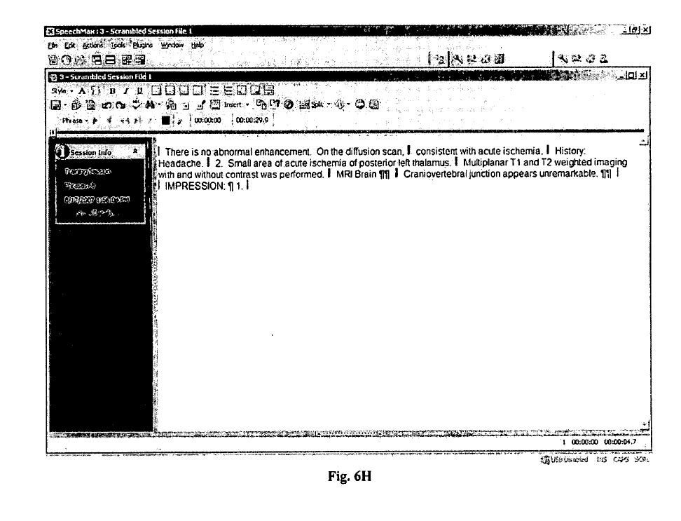

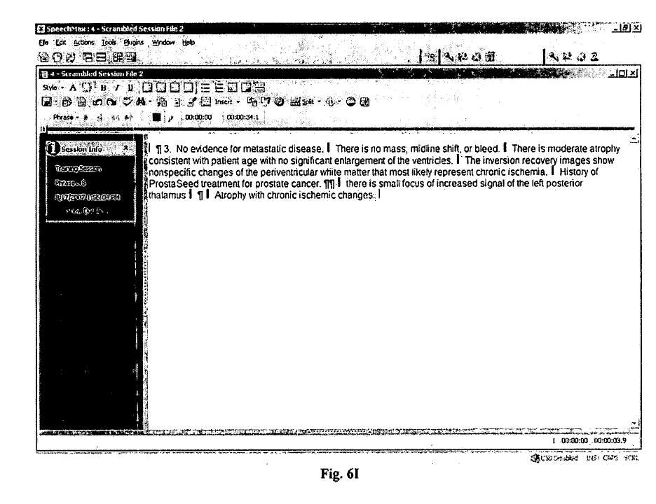

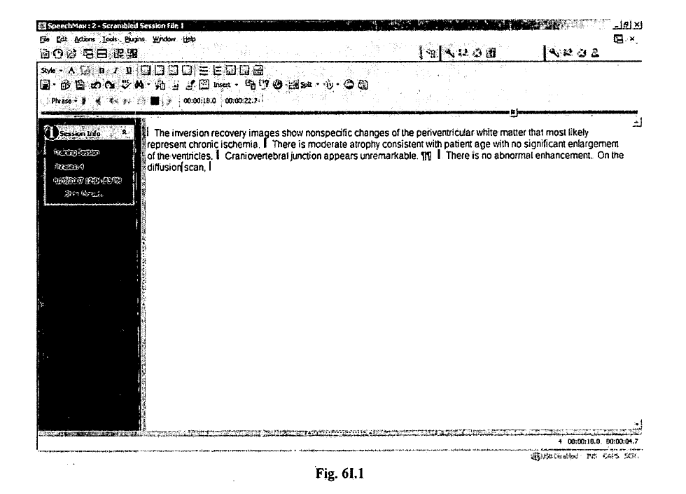

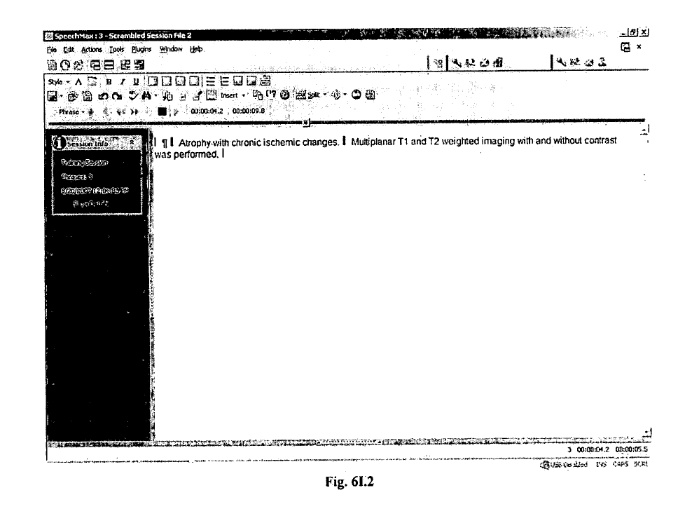

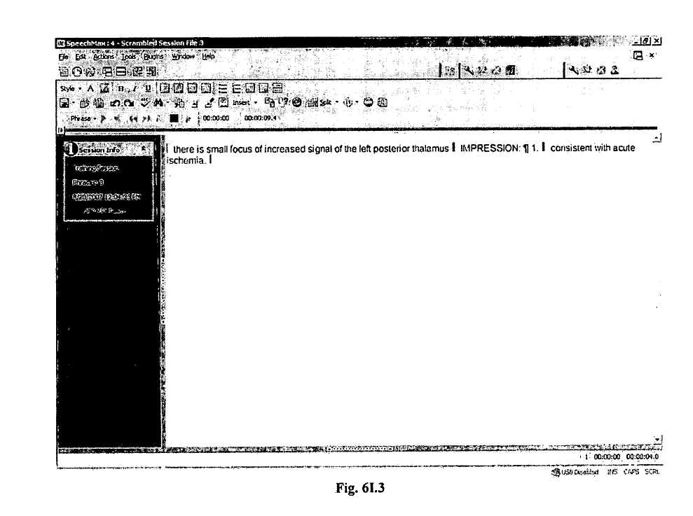

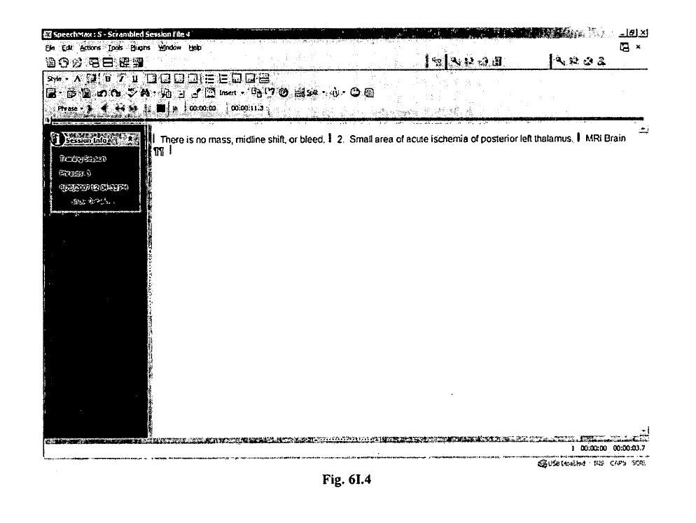

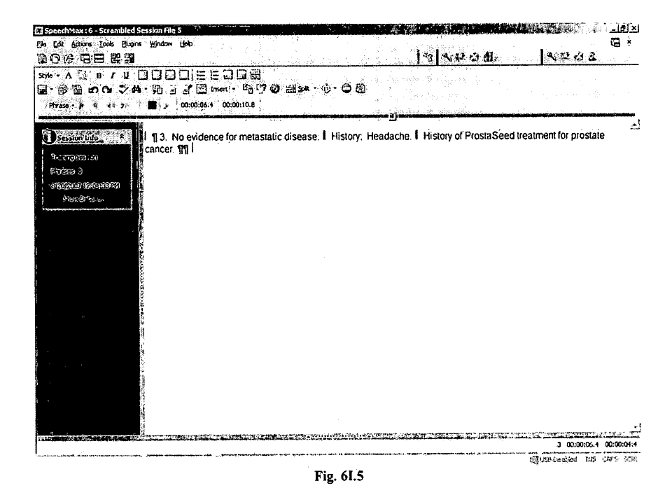

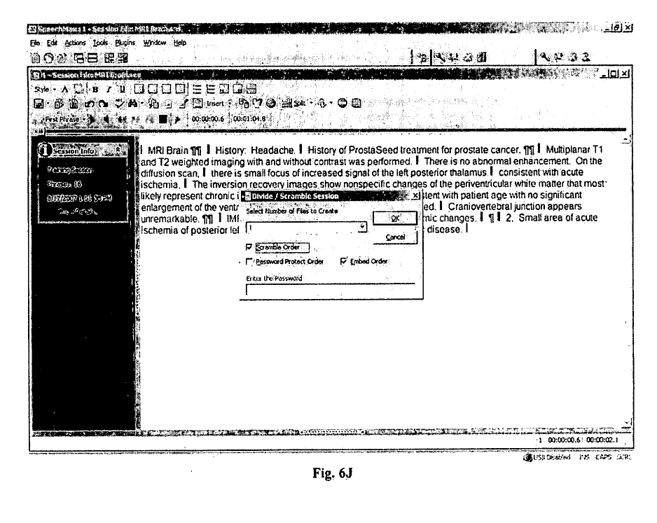

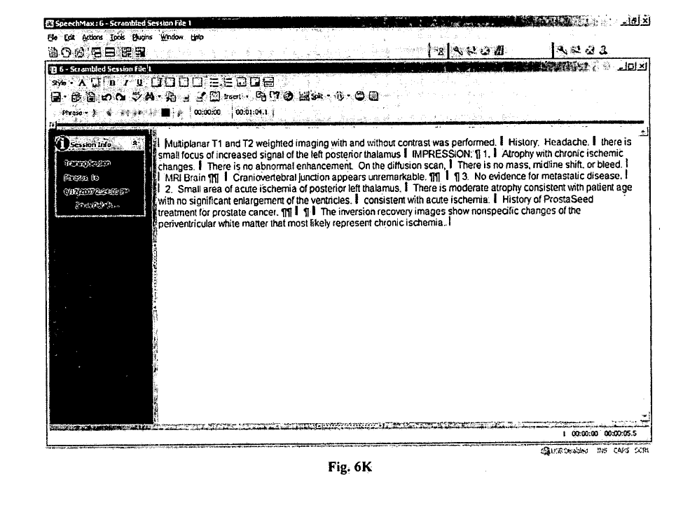

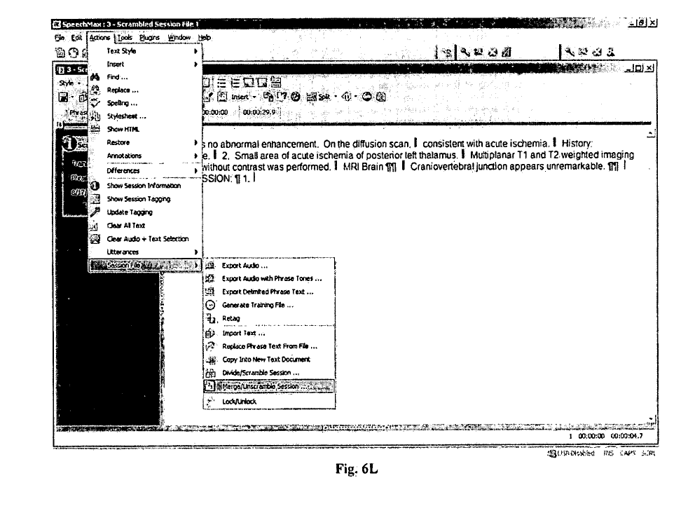

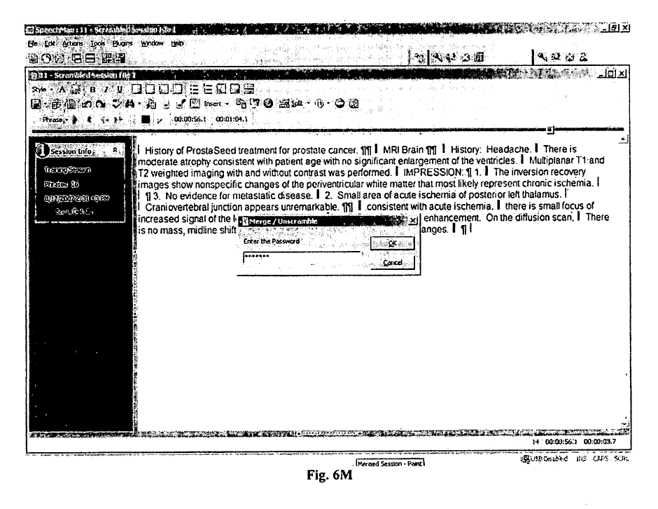

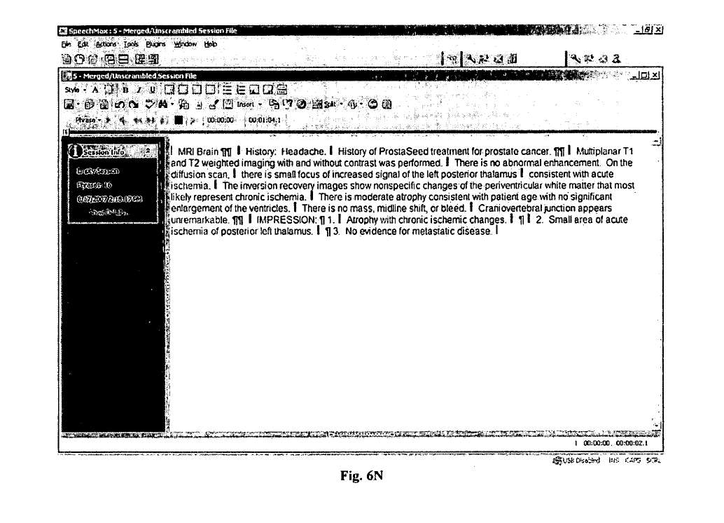

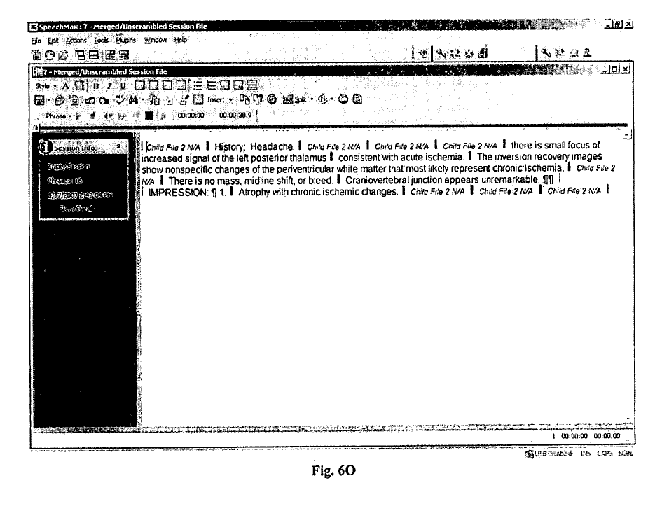

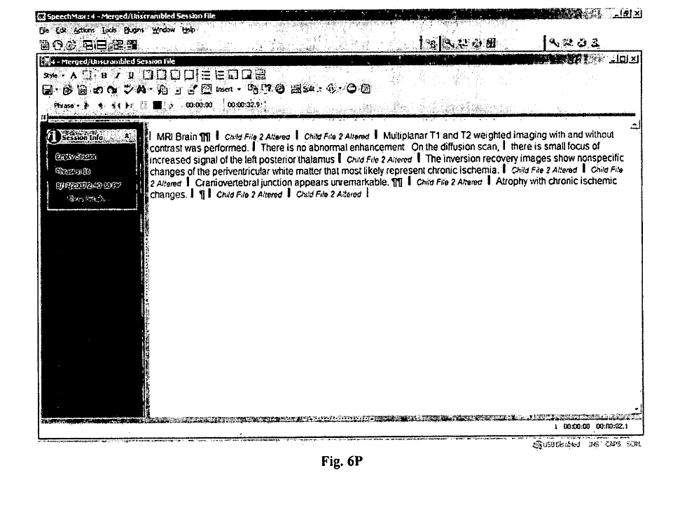

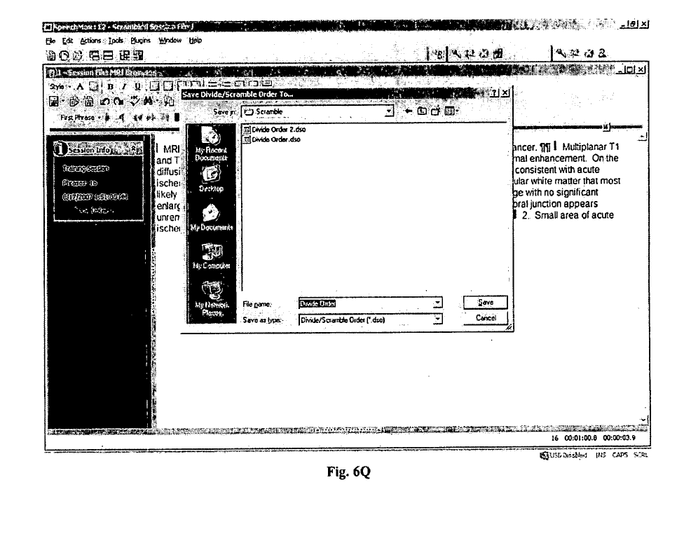

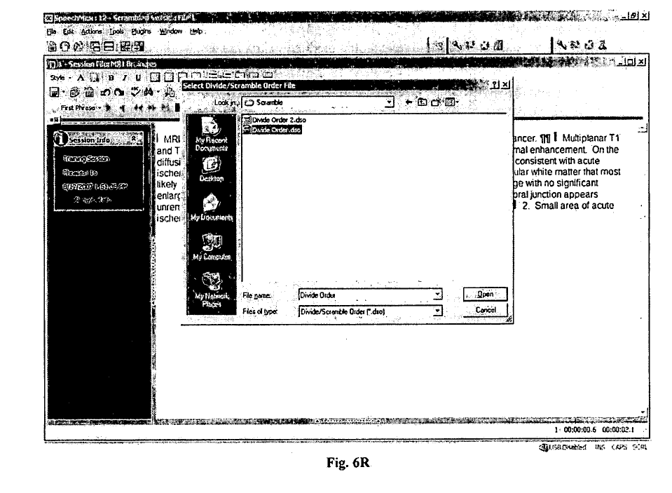

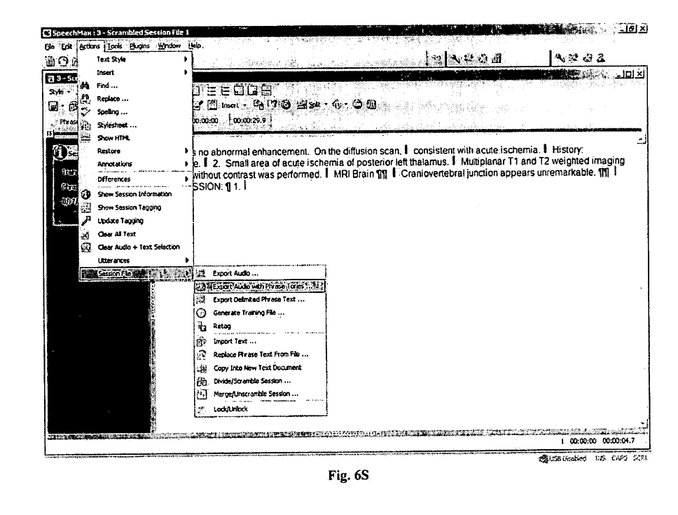

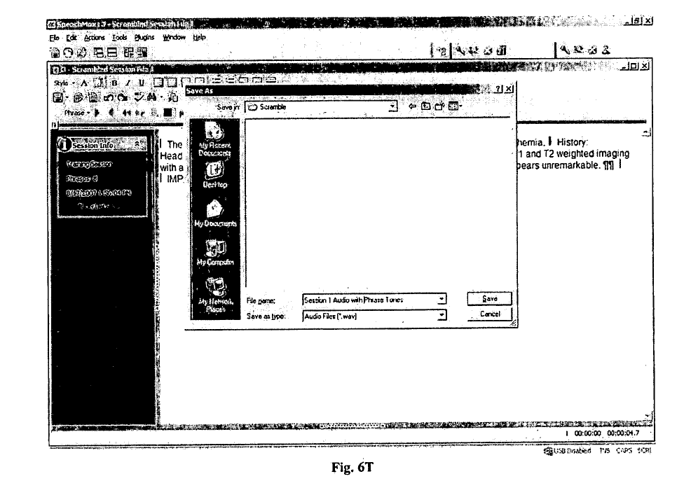

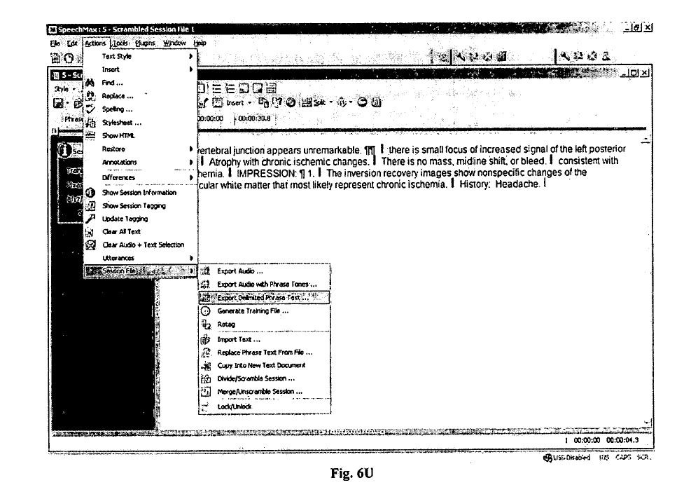

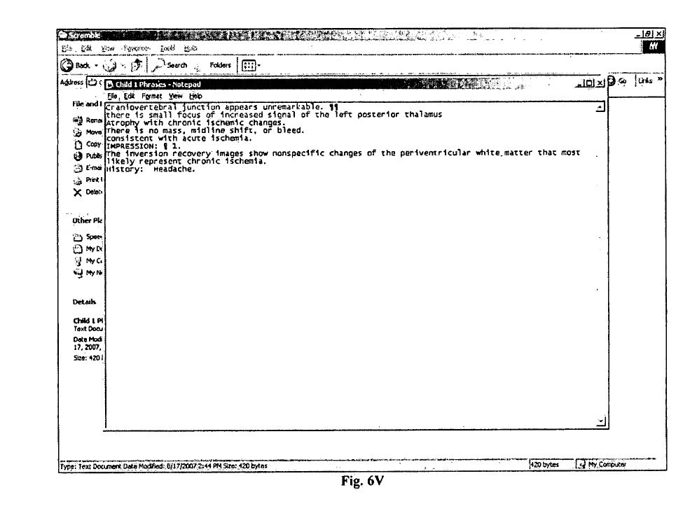

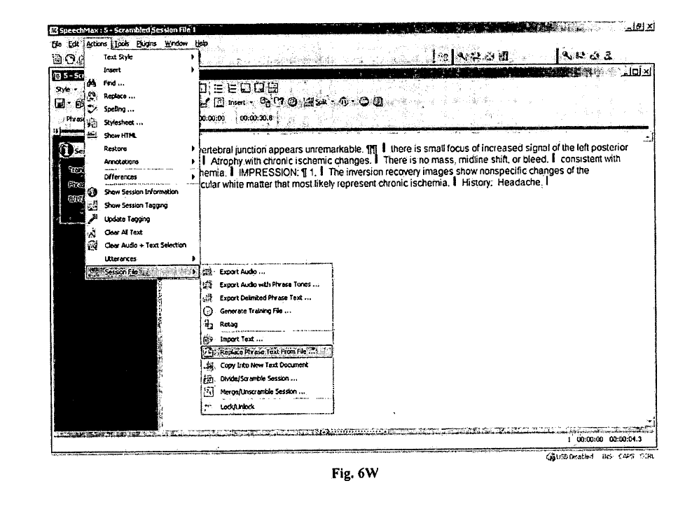

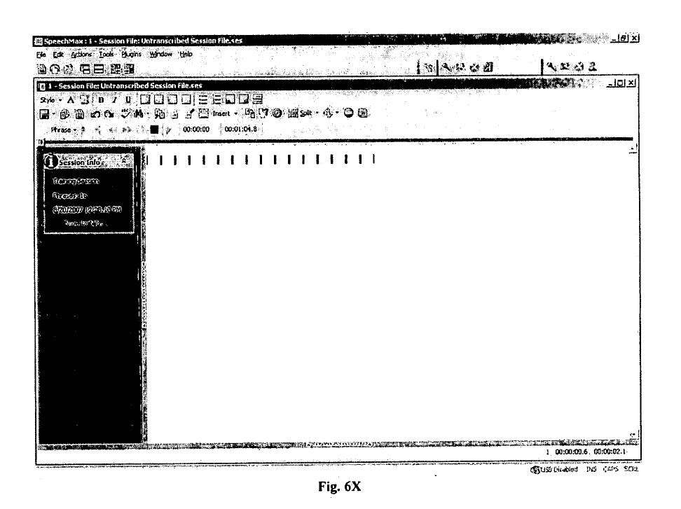

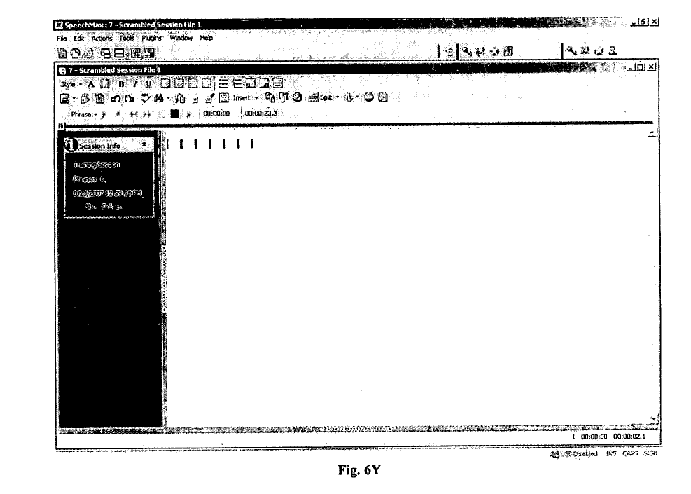

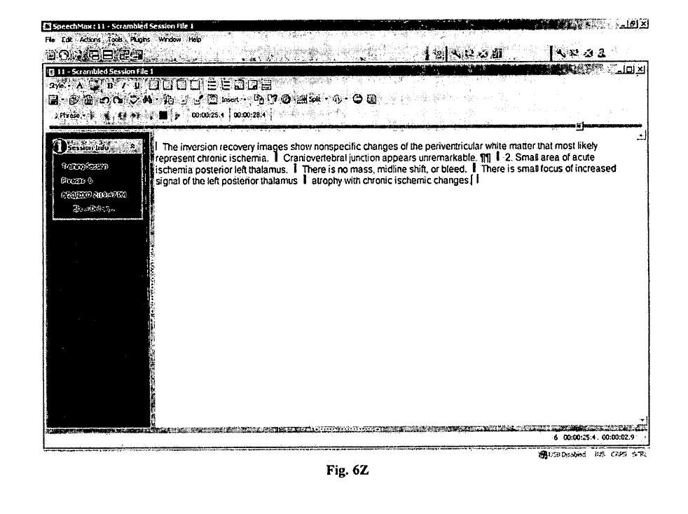

By selecting scramble 211, but not divide 209, the result is a single child session file 225 with scrambled (reordered) segments. By selecting not to scramble 211, but to divide 209, the result is two or more child session files 225 with unchanged segment order. If the operator selects both (divide 209 and scramble 211), the result is two or more child session files 225, each with reordered segments. A graphical user interface supports these options in a variety of sequences (see FIGS. 6A-6Z).

With divide 209, the operator creates n child session files session files 225 where n>1 from the parent session file 207. If divide 209 is not selected, the result is n=1 child session files 225. In this case, the single child session file 225 will have the same number of segments N as the parent session file 207, such that n=N. The number of segments s in each child session file 225 is no greater than the original number of parent session file 207 segments N.

If the operator selects divide 209 and creates two or more child session files 225 from the parent session file 207, the number of segments s in each child session file 225 is no greater than the original number of parent session file 207 segments N divided by the number n of new child session files 225, plus a remainder (r). That is, s<N/n+r. If the: original parent session file 207 segments N is not divided evenly by the number n of child session files 225, the remainder r one or more segments may be, in a preferred approach, assigned to each child session file 1, . . . , n. Where r>1, one remainder segment may be assigned to each of one or more child session files 225.

In this approach, if the parent session file 207 has eleven segments with n=2 divisions selected in the divide 209 step, there will be two child session files 225, one with six segments and one with five: 11/2 [symbol] 5 minimum+1 remainder. If there are N=11 parent session file 207 segments and n=3 child session files 225, there will be child session files, two with four segments, and one with three segments: 11/3 [symbol] 3 minimum+2 remainder. That is, the remainder r=2 segments may be assigned one each to the first and second child session files 225. These two child session files 225 will each have four segments (s=4). The third child session file 225 will have three segments (s=3).

With scramble 211, the process typically will pseudo-randomly reorder the 1, . . . , N segments if N>1 [symbol] 1ₙ, . . . , Nᵣ. The subscript refers to random rearrangement of segments in the newly-created one or more n child session files 225. The segments in the parent session file 207 may undergo scramble 211 by assigning a random position to each segment 1, . . . , N in the one or more child session files 225 1, . . . , n. If scramble 211 is not selected, the segment order for each of the one or more child session files 225 corresponds to parent session file 207 order for the segments included in the child session files.

With a parent session file 207, text, audio, and image data content may be reordered and associated to other bounded divisions. If the parent session file 207 contains audio only (as with an untranscribed session file), the audio segments may be reordered. If the parent session file 207 includes text and audio (as with a transcribed session file), the audio and text may be reordered. Other data content displayed as images volumes, or k-space may be randomly reordered.

After creation of one or more child session files 225, a user may determine that private information is included in adjacent segments or otherwise inadequately hidden after divide 209, scramble 211, or both. The operator may decide to redo 227, thereby returning to the original session file 201 for optional preprocess 203 before creation of parent session file 207 for selection of options divide 209, scramble 211, embed order 213, or create password 215. At decision point distribute only audio to one or more nodes 229 (which applies to export of audio for manual transcription), in a preferred approach, the process may decide “no.” It then may distribute one or more child session files 225 to one or more nodes 230 for manual or automated processing or both 231 to produce one or more processed child session files 233. This may include processing by the exemplary session file editor 160.

During manual or automated processing or both 231, the one or more of the child session files 225 may be processed using the exemplary session file editor 160. For example, an untranscribed child session file 225 may be transcribed manually with the session file editor 160 or with application program 150 server-based speech recognition. A transcribed child session file 225 produced manually or with application program 150 real-time or server-based speech recognition may be edited manually using the session file editor 160. One or more other child session files 225 with other data content may also be processed to produce one or more processed child session files 231. After processing 231, the number n of processed child session files 233 should equal the number of one or more child session files 225. Further, the number of segments s in each processed child session file 233 should equal the number of segments in the corresponding original child session file 225. After manual or automated processing or both 231, throne or more processed child session files 233 may be returned to source or other node 235.

After return 235, the one or more processed child session files 233 may undergo review 237. During review 237, the operator may determine if the returned session files include both one or more child session files 225 and one or more processed child session files 233. Corresponding child 225 and processed child session files 233 have identical order 217 and time stamp 219 data. As a manual check to separate one or more child session files 225 from one or more processed child session files 233, the operator may view a file list in a folder in the Windows® operator system and view date/time created, accessed, and modified. The one or more processed child session files 233 will have a later modified date/time.

After completing review 237, at decision point insert/replace phrase text 238 (which refers to processing of audio by manual transcription), in a preferred approach, the process decides “no” in order to begin steps for leading to session file reassembly 281. To begin process, a user may open one or more processed child session files 233 in one or more documents windows of the exemplary session file editor 160, select an active session file by clicking on the document window, and launch reassembly by clicking the merge/unscramble menu item of the session file editor 160. If the active session is a processed child session file 233 of a divide 209, scramble 211, or both, and the session file editor 160 finds embedded order and time stamp, it will extract embedded order and time stamp from selected child session file 241. It may merge, unscramble, or both 279 all session files open in the session file editor 160 that share the same time stamp. The result is a reassembled session file 281.

If the deconstruction order is not embedded, and saved with time stamp 221 to an order and time stamp file 249, the session file editor 160 may prompt the user to browse for and specify external order and time stamp file 249, i.e., the .DSO “divide scramble order.” Once selected, this may extract order and time stamp from the order and time stamp file 250. Subsequently, the session file editor 160 may merge 269, unscramble 271, or both all opened processed child session files 233 that share the same time stamp as saved to the .DSO order and time stamp file 249.

Decision point user defined password required 251 indicates that mapping data 420, as described in relation to FIG. 4, may be password protected and require password entry. If password protected, a dialog may appear that user must enter password 257 followed by compare password 259 and determination 261 of match. If there is no match, user must enter password 257 again. If there is a match 265, the process may identify one or more other child session files by time stamp 267. This will launch merge, unscramble, or both 279 to produce reassembled session file 281.

After launch of merge/unscramble from menu item, the process may identify that there are missing or altered session files. Embed order data 213 and time stamp 223 save mapping data 420, as described in relation to FIG. 4, to one or more child session files 225. Save order and time stamp file 221 save mapping data 420 to the external order and time stamp file 249 with .DSO extension. With this information, the process can identify matching child session files 271 and what one or more child session files 225 were created at the time of divide 209, scramble 211, or both by time stamp 267, and the number and original position of each of the segments s in the n child session or processed child session files 225.

Using mapping data 420 in relation to the active session file, the process may generate a list of one or more missing child session files by time stamp 269. It may also identify one or more child session files with altered phrase number 273. With this identification, the process may also generate a list of one or more altered child session files 275 and a list of one or more unaltered child session files 275.

An altered number of phrases (segments) within a child 225 or processed child session file 233 may result from inadvertent use of add/delete segment features of exemplary session file editor 160. With add or delete one or more segments, the association of original segment position in parent session file 207 to position in child 225 or processed child session file 223 with mapping data 420 will typically not be maintained. However, without position mapping, segments from one or more altered child session files 275 cannot be used during merge, unscramble or both 279 to create reassembled session file 281.

This information concerning missing child session files 269 and altered child session files 275 may be displayed in the session file editor 160 document window with the reassembled session file 281. In one approach, this display may indicate, by segment, which segments are missing because the one or more child 225 and processed session files 233 are not available (e.g., “Child File N/A”), and which segments are missing because they are from the one or more child 225 or processed child session files 233 with altered segment number e.g., (“Child File Altered”). Missing (“N/A”) files 269 may have been processed, but may not be opened in the session file editor 160 document windows during process of identify one or more other child session files by time stamp 267.

The reassembled session file 281 with missing/altered session files are subject to review 283. During this step, a user may repair a child session file with altered phrase number using split/merge audio and text functionality available in the exemplary session file editor 160. In one approach, the operator may open the original child session file 225 in one document window of the session file editor 160, compare segment number, and make changes using split/merge functionality to the processed child session file 233 to increase/decrease segment number for a “Child File Altered”. When the two session files are synchronized (equal segments), navigation to sequential segments with the tab key is supported. This represents one way to test for equality of segment number. Further, where there is a missing child session file by time stamp 267, the operator may open the original child session file 225 and complete transcription or other processing to generate the missing processed child session file 233 (“Child File N/A”).

With repair of altered phrase number and replacement of missing session file, the user may restart the process of reassembly, beginning with decision point whether to specify order and time stamp file 239. This may be included in optional redo 285.

Returning to decision point distribute only audio to one or more nodes 229, in the preferred approach, an operator may use the exemplary session file editor 160 to process one or more child session files 225 to create one or more processed child session files 233. Lacking audio-text tagging and synchronization, a word processor cannot easily track audio associated to transcribed or edited text.

However, some users may prefer to playback audio file and transcribe in widely used application programs 150, such as the word processors Microsoft® Word or WordPerfect® that do not support text selection and playback of audio-linked text. In this setting, process may elect to have manual transcription performed with playback of audio file with foot pedal 110 using application programs 150 audio playback software and word processor. If the process determines 229 yes to distribute only audio to one or more nodes 229, it may create and export phrased toned audio 230a corresponding to each segment. In one approach, this may be a continuously playable audio file where a short tone has been inserted. This may be placed in the audio file corresponding to the end of each segment of the child session file 225.

If there are n child session files, the process may create and export n audio files and distribute audio to one or more nodes 230b. If there are s segments in a given child session file 225, the audio file from export of phrased toned audio 230a should have s tones corresponding to segment number within a given session file. Operator may use foot pedal 110 with for manual transcription 230c with application programs 150 transcriptionist audio playback and word processor. This process may create one or more text delimited files 230d. These files may be line delimited, comma delimited, tab delimited, or otherwise delimited. These files may be returned to source or other node 235 for review 237. Review 237 may include preliminary editing.

After review 237, process may reach decision point whether to replace/insert phrase text 238a in one or more child session files 225. These child session files 225 may represent untranscribed session files (segmented audio only) or transcribed session files (audio-linked from manual processing, speech recognition, or both). The child session files 225 also may have been created from a parent session file 207 from a speaker dictating into a “fill-in-the-blank” form using the annotation sound recorder and copying audio into the main read/write window so that it is audio-linked to text. If process determines “yes” to replace phrase/insert text 238a, it may next determine 238b if phrase counts match. In one approach, the process may compare the line count in line-delimited transcribed phrases to the number s of segments in the child session file 225 from which the phrase-toned audio was exported. If “yes” (match), the process may replace/insert each session file phrase with text phrase 238c to create one or more processed child session files 233. These processed child session files 233 are identical to those created by manual or automated processing or both 231 using other application programs 150 or exemplary session file editor 160. After replace/insert phrase text to produce one or more child session files 233, the process determines whether to specify order and time stamp file 239, and may begin steps towards creating reassembled session file 281.

If phrase counts do not match at decision point 238b, the process may send the audio to review 237 for further evaluation, possible rework of text processing, or other processing. Once delimited text phrases have been added or deleted and appear to match segment number n, these may be resubmitted to insert/replace phrase text 238a in one or more child session files 225.

Those skilled in the art with the present specifications before them will further recognize that the replace/insert feature may be used in other settings where there has been no divide 209, scramble 211, or both. In these cases, not specifically illustrated in FIG. 2, export phrase toned audio file may be applied to one or more session files 205. The audio may be transcribed using foot pedal 110 and application programs 150 transcription audio playback software and word processor. In one approach, for example, after creation a session file from a speech recognition program that loads as a plugin application program 150 with the session file editor 160, an operator may export phrase toned audio file for manual transcription. The line delimited transcription (one or more delimited text files) may be returned to replace/insert text phrase into a session file. Similar approach may be applied to session file 205 produced by server-based speech recognition application programs 150. Further, as described in relation to FIGS. 6U, 6V, and 6W, text as well as audio may be exported from a session file 205 to create a delimited text file. For instance, transcribed text may be exported, segment by segment, to a line-delimited text file where the operator reviews with playback of phrase toned-audio file.

The examples of invention application have focused on protection of privacy and confidentiality of audio and text associated to dictation, transcription, and speech recognition, but segments with other data content, such as pictures or other images, associated to a segment may be divided, scrambled, or both. Those skilled in the art related to study of human perception and understanding will further recognize that divide 209, scramble 211, or both features may be used to create testing materials with audio-linked text and other data content, including images or other audio such as music or unusual sounds. Other applications may be of benefit in other fields such as phonics, phonetics, foreign language training, and other education, including, but not limited to, training of transcriptionists and speech recognition editors.

Session File

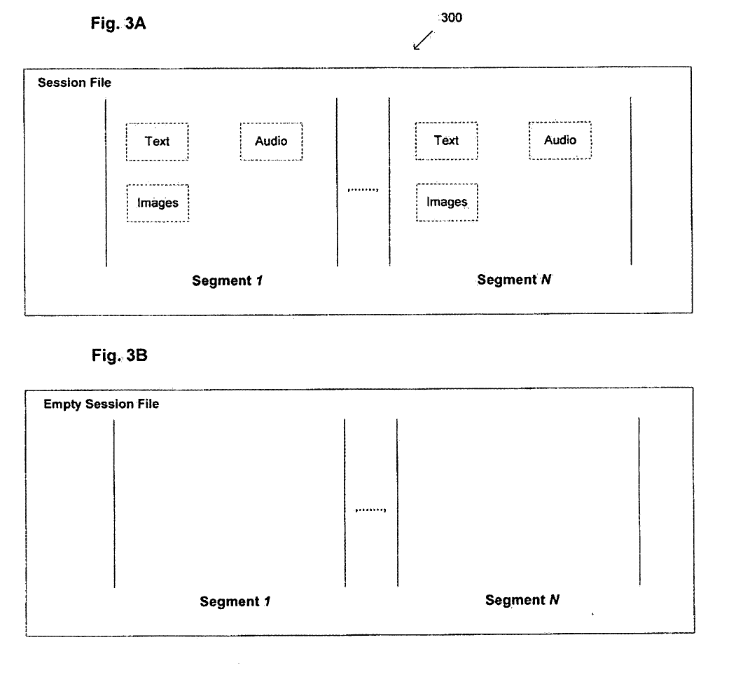

In one approach, the session file (.SES) is binary and zip compressed using techniques well known to those skilled in the art, such as is available with zip compression from various developers. The compacted, binary proprietary session files may be opened and modified in the exemplary session file editor 160. Bounded divisions may consist of segments, areas, volumes, or spaces. As disclosed in relation to FIG. 3A, the one or more session files 205 may consist of a plurality of 1 through N segments, areas, volumes, or spaces each with content consisting of one or more optional text, audio, image, or other data elements. As disclosed in relation to FIG. 3B, an “empty” session file may consist of a plurality of boundary divisions only with no data elements, but may be converted into one or more session files 205 with content by manual or automatic processing that adds a plurality of data elements. With speech and language processing, the boundary divisions will typically consist of segments displayed sequentially in the exemplary session file editor 160. With a transcribed one or more session files 205, the operator may select text and playback associated audio.

Mapping Data 420

Parent session file 207 with 1, . . . , N bounded divisions may undergo divide 209 into 1, . . . , n one or more child session files 225. The number of bounded divisions in each of the one or more child session files 225 may differ. These bounded divisions may consist of segments, areas, volumes, or spaces. In the dictation and transcription field, the one or more child session files 225 may consist of a plurality of transcribed session file with segments with audio-linked text, untranscribed session files: with segmented audio only, or dictation into a fill-in-the-blank form.

As disclosed in relation to FIG. 4A, a segmented session file may consist of a plurality of 1 through s segments with one or more optional text, audio, image, or other data elements with segment number s. Divide 209 may produce Child Session File 1 has I through S₁ segments. Child Session File n has Sₙ, through N segments. Each segment in the parent session file 207 is included in only one of the n child session files. The “N” refers to the Nth segment. The plurality of n child session files 225 as a whole includes parent session file 207 segments 1, . . . , N. The number of s segments in each of the plurality of child session files 225 may differ. In a preferred approach, the segment number should not differ by more than one. One or more of the s segments in each child session file 225 may consist of “empty” segments with no data content.

As disclosed in relation to FIG. 4D, mapping data 420 contains time stamp 425 information that is used to identify the one or more child session files 225 resulting from a particular divide 209, scramble 211, or both. With both (divide 209 and scramble 211) occur, they occur, transparently to user, as an apparently single event with a resulting single time stamp 425. As the time stamp 425 contains time to the millisecond level, there is a high probability that the time stamp 425 is a unique identifier for the plurality of child session files 225 resulting from a divide 209. Alternatively, the process may include a Globally Unique Identifier or GUID, a 128-bit integer (16 bytes) identifier in the Microsoft® operating system to provide a reference number in a software application, as those skilled in the art will recognize. While each generated GUID is not guaranteed to be unique, the total number of unique keys is very large, making it improbable that the same number would be generated twice.

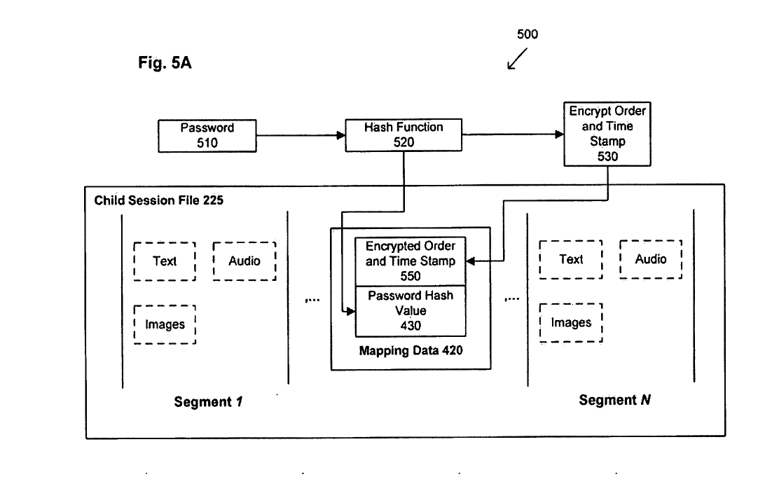

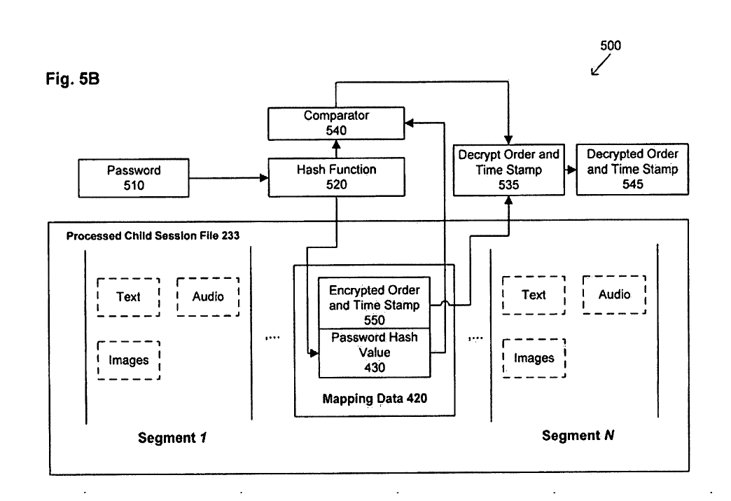

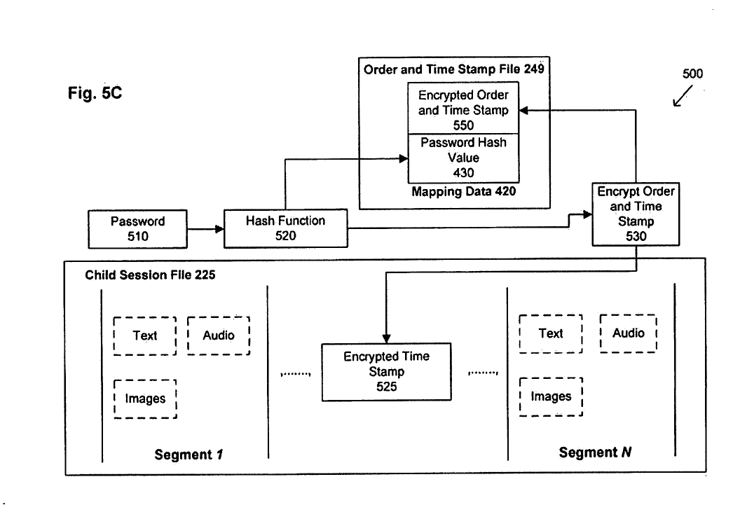

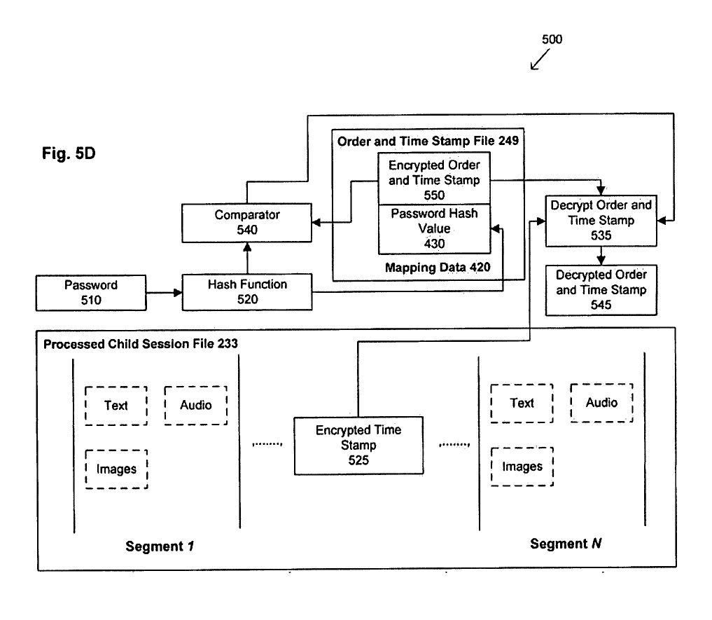

As further disclosed in relation to FIG. 4D, mapping data 420 preferably includes password hash 430. The password hash 430 may represent a small digital identifier derived from any kind of data. Hash functions may include a cryptographic hash function, a security hash table, an associative array, and geometric hashing. In one approach, the password hash 430 is set to a default value. In this approach, the default value may be overridden by create password. In the preferred approach, the process includes embed order data and password into the one or more child session files as part of the XML session file markup, or into an order and time stamp file. As further described in relation to FIGS. 5A (Embed Mapping Data), 5B (Extract Mapping Data), 5C (Export Mapping Data), and 5D (Import Data) the password hash 430 is associated to encrypted order and time stamp 550 within mapping data 420.

FIG. 4D also discloses that mapping data 420 includes positional data about each of the original segments 1, . . . , N of the parent session file 207 in relation to each of the n segments of the plurality of child session files 225. As disclosed, for each of the original 1, . . . , N segments, this includes data recording the segment original order 435 in the parent session file 207, the new order 440 in the child session file 225, and file placement n 445 indicating the child session file 225 number. File placement n indicates the child session file that the segment has been placed into. As the mapping data 420 includes positional data for each parent session file 207 segment in relation to each child session file 225 segment, mapping data 420 includes data about the total segment number in parent 207 and child 225 session files.

Mapping data 420 is included in child session files 225. It identical in processed session files 233. In merge, unscramble or both 279 the process uses mapping data 420 to create reassembled session file 281 with segment 1, . . . , N sequence identical to the original parent session file 207.

As further disclosed in relation to FIG. 4B, the process may undergo scramble 211 with no divide 209. Each of the 1, . . . , N segments of the parent session file 207 is randomly assigned a new position in a single child session file 225, e.g., Child Session File 1. To indicate the random position, each of the 1, . . . , N segments has an added subscript “R,” e.g., 1_{R}, . . . , N_{R}. Mapping data 420 is also included in the child session file 225 and single processed session file 233. It is used in merge, unscramble, or both 279 to create reassembled session file 281 with segment 1, . . . , N sequence identical to the original parent session file 207.

As further disclosed in relation to FIG. 4C, the process may undergo divide 209 and scramble 211. With divide 209 (n=1), each of 1, . . . , N segments of the parent session file 207 is assigned to one of the n child session files 225. With divide 209 (n≧2), 1, . . . , N segments of the parent session file 207 is assigned to two or more child session files 225. Further, with scramble 211, each segment within each child session file 225 may be randomly assigned a position. As a result, each of the 1, . . . N segments of the parent session file 207 is included in a child session file 225, and randomly assigned a new position in the two or more child session files 225. To indicate the random position of each segment S in each of the n child session files 225, each of the 1, . . . , N segments has an added subscript “R.” For example, as disclosed, 1_{R}, . . . , S_{1R} and S_{nR}, . . . , SN_{R} have been displayed for the first and last segments of Child Session File 1, and first and last segments of Child Session File n. As before, mapping data 420 is also included in the one or more child 225 and processed session files 233. It is used in merge, unscramble, or both 279 to create reassembled session file 281 with segment 1, . . . , N sequence identical to the original parent session file 207.

Embed/Extract/Export/Import Mapping Data 420

In one approach, the process may optionally divide 209, scramble 211, embed order 213, and enter password 215 with nonoptional embed time stamp 217 before creation of one or more child session files 225 with embedded and encrypted mapping order and time stamp data 420. In the embed mapping data 420 process, as disclosed in relation to FIG. 5A (Export Mapping Data), a password 510 is processed by a hash function 520 to encrypt order and time stamp 530 that results in embedded encrypted order and time stamp 550. The hash function 520 creates the password hash value 430 within mapping data 420 embedded in the child session file 225.

In one approach, before merge, unscramble, or both 279 with reassembled session file 281, process may extract embedded order and time stamp from selected child session file 241 after enter password 257 with match 261. The child session file is usually a processed child session file 233. In the extraction mapping data 420 process, as disclosed in relation to FIG. 5B (Import Mapping Data), the hash function 520 passes password 510 data to password hash value 430 and comparator 540 which receives password hash value 430 for comparison for decryption of encrypted order and time stamp 550. This results in determination to decrypt order and time stamp 535 and decrypted order and time stamp 545 external to the processed child session file 233. The original encrypted order and time stamp 550 remains embedded in the session file mapping data 420.

Process may optionally determine to divide 209, scramble 211, and embed order 213. If the process determines not to embed order 213, process may save order and time stamp file 221, typically to an external order and time stamp file 249 with .DSO extension (“divide scramble order”). In the export mapping data 420 process, as disclosed in relation to FIG. 5C (Export Mapping Data), a password 510 is passed to a hash function 520 that sets password hash value 430 within the order and time stamp file 249. This is followed by encrypt order and time stamp 530 and encrypted order and time stamp 550 within the mapping data 420 of the order and time stamp file 249 and encrypted time stamp 525 within the child session file 225.

Before reassembly session file 281, process may import order and time stamp from order and time stamp file containing mapping data 420. As explained in relation to FIG. 5D (Import Mapping Data), import mapping data may start with password 510 passed to hash unction which passes password data to comparator 540 which receives password hash value 430 from order and time stamp file 249. With match, encrypted order and time stamp 550 from within order and time stamp file 249 and encrypted time stamp from processed child session file 233 results in decrypt order and time stamp 535. Decrypted order and time stamp 545 are processed external to both the order and time stamp file 249 and session file 233.

III. Graphical User Interface: Divide/Scramble Merge/Unscramble

In one approach, an operator may open a transcribed or other session file 205 in the exemplary session file editor 160. As shown in FIG. 6A, the title bar of the main read/write window and document window both display “Session File” for this transcribed parent session file 207 radiology report MRI Brain created from manual transcription or real-time or server-based speech recognition. Menu and toolbars for the read/write and document windows are displayed. Information about the transcribed session file is available by clicking the “Show Details” item in the left-hand Session Info panel, as shown in FIG. 6B.

To divide 209/scramble 211 the parent session file 207, the operator may click the Actions menu of the main window, “Session File,” and “Divide/Scramble Session . . . ” (FIG. 6C), select number of files to create from Divide/Scramble dialog (here two) (FIG. 6D), view divide 209 only child session file 225 one (FIG. 6E), and view divide only child session file 225 two (FIG. 6F). The process may distribute the session files to one or more nodes 239 for manual or automated processing or both 231.

Alternatively, user may divide 209 and create two files, scramble 211 order, password protect 215 with respect to transcribed parent session file 207 (Fig. G). The user may view child session file 225 one (Fig. H) and child session file 225 two (Fig. I). To further promote privacy and confidentiality and limit knowledge of any one operator, a user may divide 209 the parent session file 207 into five segments and scramble. Results are shown in FIGS. 6I.1-6I.5. The reassembled session file 281 represents the same parent session file radiology report MRI brain displayed in FIG. 1.

In another alternative, operator may begin with transcribed parent session file 207, elect to scramble 211 only with no divide 209, embed order with no enter password 215 (FIG. 6J), and produce a single scrambled only child session file (FIG. 6K).

After creation of one or more processed child session files 233, return to source node or other location 235, and review 237, operator may initiate steps to create reassembled file 281. Operator may open processed child session 233 as active session file (in this case parent session file 207 processed with divide 209 and scramble 211), and click Actions menu of the main window, “Session File,” and “Merge/Unscramble Session . . . ” (FIG. 6L). System may determine that password is required 251 and open dialog prompting user (FIG. 6M). After enter password 257 and completion of merge, unscramble, or both 279, the reassembled session file 281 is displayed (FIG. 6N). In some instances, there may be segments representing one or more missing child session files by time stamp 269 (FIG. 6O) or one or more altered session files 275 (FIG. 6P).

If operator elects not to embed order and instead save order and time stamp file 221, dialog may appear to save .DSO file (FIG. 6Q). After processed child session file 233 is selected as active session and operator initiates process of merge, unscramble, or both 279, the user may be prompted to open the .DSO file (FIG. 6 R).

In an alternative approach, process may elect 229 to distribute only audio to one or more nodes. The operator may open a child session file 225 produced from part of an unedited speech recognition transcribed session file created from divide 209 and scramble 211. The operator may click the Actions menu of the main window, “Session File,” and “Export Audio With Phrase Tones . . . ” (FIG. 6S), save the scrambled exported audio with phrase tones (FIG. 6T), and distribute the audio to one or more nodes 230b for manual transcription 230c using application program 150 word processor.

Further, the operator may click on menu item “Export Delimited Phrase Text” to create a delimited text file of the text from the divided/scrambled speech recognition (FIG. 6U). A delimited text file 230d in Notepad or other text processor file (FIG. 6V) may be returned to source node or other location 235 for review 237. User may click the Actions menu of the main window, “Session File,” and “Replace Phrase Text from File . . . ” (FIG. 6W) to automatically replace/insert 238d the delimited text 230d into the unedited child session file 225 to create a processed child session file 233. One or more processed child session files 233 may undergo merge, unscramble, or both 279 to create a reassembled session file 281 including human transcribed text.

Further, an operator may begin with a parent session file 207 representing an untranscribed session file, segments with audio only, as displayed in FIG. 6X. This represents the untranscribed session file corresponding to the radiology MRI Brain transcribed session file report in FIG. 6A. Both session files have sixteen segments. The untranscribed session file may undergo divide 209 and scramble 211 into three: child session files 225, with one of the child session files 225 displayed in FIG. 6Y. Transcription of the scrambled untranscribed child session file 225 is displayed in Fig. Z. After transcription of the three untranscribed, scrambled child session files 233 and merge, unscramble, or both 279, the reassembled session file 281 has the data content of MRI Brain report (FIG. 1A).

The graphical user interface of the session file editor 160 may also provide user options for mapping data 420 and block/unblock decryption of order and time stamp data in mapping data 420.

Further, while not specifically illustrated in FIG. 2, in one approach each child session file 225 may be sent to two or more processing nodes to produce two or more processed child session files 233 that undergo merge, unscramble, or both 279 and result in reassembled session file 281. These two or more reassembled session files may each be opened in the exemplary session file editor 160.

In the review 283 step, each may be text compared using techniques, as described in '671 application and other copending applications, to reduce correction time by identifying highly-reliable text and minimizing need to listen to corresponding dictation audio during review 283.

In a related approach, a composite “best-guess” session file, as described in '671 application and other copending applications may be created that indicates likely accuracy of text by color-coding. This color coding may indicate occurrence frequency in session files derived from same dictation audio, thereby potentially reducing need to actually listen to entire audio file. In one approach, red highlight may indicate high degree of uncertainty and need to review dictation audio. Clear (no) highlight may indicate complete agreement between texts and less need to listen to the dictation file.

Similarly, phrase toned audio 238a file may be sent to two or more processing nodes to produce two or more processed child session files 233 that undergo merge, unscramble, or both 279 and result in two or more reassembled session file 281. These may be evaluated using text compare or composite, “best-guess” techniques.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

1. An system comprising:
a session file containing at least two bounded divisions;
a function for disassembling the session file;
a session file editor for editing at least one bounded division included in the session file; and
a function for reassembling the at least two bounded divisions back into the same order as the session file.

2. The system of claim 1 wherein each of the bounded divisions of the session file are selected from the group comprising: (a) null, (b) audio and null text; (c) audio and text associated with the audio; (d) audio, an image associated with the audio, and null text; (e) audio, an image associated with the audio and text associated with the audio; and (f) null audio and text; (g) null audio, null text and image; and (h) null audio, text and image.

3. The system of claim 2 wherein the function for disassembling the session file includes dividing the at least two bounded divisions of the session file into one of at least two child session files, the session file further including mapping data that maintains the relationship of the at least two bounded divisions between the session file and the at least two child session files.

4. The system of claim 3 wherein the function for disassembling the session file further includes the scrambling of the at least two bounded divisions of the session file, wherein the mapping data further maintains the relationship between the at least two bounded divisions.

5. The system of claim 4 wherein the function for reassembling back into the same order as the session file involves unscrambling the at least two bounded divisions and merging the at least two child session files back into the session file based on the mapping data.

6. The system of claim 5 further comprising means for precluding reassembly of the at least two bounded divisions without a password.

7. The system of claim 3 wherein the function for reassembling back into the same order as the session files involves merging the at least two child session files back into the session file based on the mapping data.

8. The system of claim 7 further comprising means for precluding reassembly of the at least two bounded divisions without a password.

9. The system of claim 2 wherein the function for disassembling the session file includes the scrambling of the at least two bounded divisions of the session file, wherein the mapping data maintains the relationship between the at least two bounded divisions.

10. The system of claim 9 wherein the function for reassembling the least two bounded divisions back into the same order as the session file involves unscrambling the at least two bounded divisions based on the mapping data.

11. The system of claim 10 further comprising means for precluding reassembly of the at least two bounded divisions without a password.
